(19) United States
(12) Patent Application Publication
(10) Pub. No.: US 2019/0028698 A1
(43) Pub. Date: Jan. 24, 2019

(54) GENERATION METHOD FOR MULTI-VIEW AUTO-STEREOSCOPIC IMAGES, DISPLAYING METHOD AND ELECTRONIC APPARATUS

(71) Applicant: Theia Ltd., Hsinchu County (TW)

(72) Inventors: Yu-Hsuan Lin, Hsinchu County (TW); Tang-Hung Po, Hsinchu County (TW)

(21) Appl. No.: 16/040,497

(22) Filed: Jul. 19, 2018

Related U.S. Application Data
(60) Provisional application No. 62/535,239, filed on Jul. 21, 2017.

(30) Foreign Application Priority Data
Jul. 10, 2018 (TW) 107123901

(51) Int. Cl. H04N 13/351; H04N 13/305; H04N 13/32; H04N 13/315; H04N 13/354

(52) U.S. Cl. CPC H04N 13/351; H04N 13/305; H04N 13/354; H04N 13/315; H04N 13/32

(57) ABSTRACT

The generation method for a multi-view auto stereoscopic image of the present invention calculates a disparity between a first view and a second view captured from a certain scene and disregards the second view. A processing unit utilizes merely the first view and the disparity to generate, via a loop mode algorithm, a plurality of disparity images suitable for synthesizing a stereoscopic image, which allows the first view and the second view to be captured at any angle. Furthermore, the displaying method and the corresponding electronic apparatus of the present invention obliquely segment the disparity images before an interlacing process and display the interlaced image via a compatible tilted lenticular lens layer, which allows the displaying apparatus to present effective stereoscopic effect at any angle. Therefore, the present application not only reduces implementation cost and image processing time but also improves convenience and versatility for shooting and viewing.

### CROSS REFERENCE TO RELATED APPLICATIONS

This invention claims the benefit of US Provisional Patent Application No. 62/535,239, filed on Jul. 21, 2017, which is hereby incorporated by reference in its entirety.

### BACKGROUND OF THE INVENTION

### 1. Field of the Invention

The invention relates to a generation method for a stereoscopic image, a displaying method and an electronic apparatus, and more particularly, to a generation method for a multi-view auto-stereoscopic image, a displaying method and an electronic apparatus.

### 2. Description of the Prior Art

When human eyes view an object, the left eye and the right eye respectively capture views of the same object, wherein a disparity exists between the image captured by the left eye and the image captured by the right eye, and thereby the brain is able to fuse the images captured by the left and right eyes to form a stereoscopic image based on the disparity.

Conventional generation method for an auto-stereoscopic image and a display device therewith utilize a pair of image capturing devices slightly spaced apart to capture a left view and a right view of the same object, wherein a disparity exists between the left view and the right view. Next, the left view and the right view are interlaced to render an interlaced image, wherein a lenticular lens layer is utilized for refracting ingredients of the left view of the interlaced image and ingredients of the right view of the interlaced image to the left eye and the right eye, respectively. Therefore, fusing the ingredients of the left view of the interlaced image refracted to the left eye and the ingredients of the right view of the interlaced image refracted to the right eye, the brain is convinced that the eyes are viewing a realistic stereoscopic image of the object.

To achieve a realistic stereoscopic image of the object, conventional display device requires at least two cameras to capture the left view and the right view of the object. To achieve a multi-view auto-stereoscopic image, more cameras corresponding to the multiple viewpoints are required to capture a corresponding number of views. As number of the viewpoints increases, the number of required cameras increases, which raises cost and image-processing time. Besides, the conventional pair of cameras is required to be configured along an orientation from the left eye to the right eye so that a comprehensive stereoscopic image can be rendered. That is, if the cameras are configured along orientations other than the orientation from the left eye to the right eye, a disparity information resulted from the captured views cannot be comprehended by the brain for conceiving stereoscopic impression, which restricts utility of the display device.

It is further noticed that interlacing procedure adopted by the conventional display device can only segment an image along a direction parallel to an edge of the image. Since the segmentation direction needs to be parallel to the orientation of the lenticular lenses so as to properly refract the interlaced image to the eyes, it is concluded that the conventional display device is restricted to a portrait displaying mode for the eyes to perceive the refracted interlaced image properly, which is also unfavorable to the utility of the display device.

### SUMMARY OF THE INVENTION

To solve the aforementioned problem, the invention discloses a generation method for a multi-view auto-stereoscopic image which includes a first image capturing device capturing a first view, a second image capturing device capturing a second view, a processing unit computing a disparity between the first view and the second view, the processing unit disregarding the second view, the processing unit generating a first disparity map based on the first view and the disparity, and the processing unit rendering N first disparity images based on the first disparity map along a rendering direction. The N is a positive integer.

According to an embodiment of the invention, the processing unit rendering N first disparity images includes the processing unit computing a virtual disparity along the rendering direction based on the first disparity map, and the processing unit computing the N first disparity images based on the first disparity map and the virtual disparity.

According to an embodiment of the invention, each of the N first disparity images includes a plurality of valid pixels and a plurality of holes. The generation method of the invention further includes the processing unit generating an image processing window including at least one part of the plurality of valid pixels and at least one part of the plurality of holes, and the processing unit filling the at least one part of the plurality of holes based on the at least one part of the plurality of valid pixels. The at least one part of the plurality of valid pixels is beside the at least one part of the plurality of holes, and the at least one part of the plurality of holes is adjacent to a window edge of the image processing window.

According to an embodiment of the invention, the generation method of the invention further includes the processing unit rendering M second disparity images based on the Nth first disparity image along a reverse rendering direction opposite to the rendering direction. M is a positive integer and equals N, and the Mth second disparity image is substantially identical to the first view the processing unit rendering M second disparity images based on the Nth first disparity image along a reverse rendering direction opposite to the rendering direction includes the processing unit computing a reverse virtual disparity along the reverse rendering direction, and the processing unit computing the M second disparity images based on the Nth first disparity image and the reverse virtual disparity.

According to an embodiment of the invention, each of the M second disparity images includes a plurality of valid pixels and a plurality of holes. The generation method of the invention further includes the processing unit generating an image processing window including at least one part of the plurality of valid pixels and at least one part of the plurality of holes, and the processing unit filling the at least one part of the plurality of holes based on the at least one part of the plurality of valid pixels. The at least one part of the plurality of valid pixels is beside the at least one part of the plurality of holes, and the at least one part of the plurality of holes is adjacent to a window edge of the image processing window.

According to an embodiment of the invention, the generation method of the invention further includes the processing unit segmenting the first view into a first view strip set along a segmenting direction obliquely intersecting an edge of the first view, the processing unit respectively segmenting the N first disparity images into N first disparity image strip sets along the segmenting direction, the processing unit respectively segmenting the M second disparity images into M second disparity image strip sets along the segmenting direction, and the processing unit interlacing the first view strip set, the N first disparity image strip sets, and the M second disparity image strip sets for rendering a display image.

According to an embodiment of the invention, the generation method of the invention further includes the processing unit rendering P third disparity images based on the Mth second disparity image along the reverse rendering direction. P is a positive integer. The processing unit rendering the P third disparity images based on the Mth second disparity image along the reverse rendering direction includes the processing unit computing a reverse virtual disparity along the reverse rendering direction, and the processing unit computing the P third disparity images based on the Mth second disparity image and the reverse virtual disparity.

According to an embodiment of the invention, each of the P third disparity images includes a plurality of valid pixels and a plurality of holes. The generation method of the invention further includes the processing unit generating an image processing window including at least one part of the plurality of valid pixels and at least one part of the plurality of holes, and the processing unit filling the at least one part of the plurality of holes based on the at least one part of the plurality of valid pixels. The at least one part of the plurality of valid pixels is beside the at least one part of the plurality of holes, and the at least one part of the plurality of holes is adjacent to a window edge of the image processing window.

According to an embodiment of the invention, the generation method of the invention further includes the processing unit rendering Q fourth disparity images based on the Pth third disparity image along the rendering direction. Q is a positive integer and equals P. The Qth fourth disparity image is substantially identical to the first view. The processing unit rendering Q fourth disparity images based on the Pth third disparity image along the rendering direction includes the processing unit computing a virtual disparity along the rendering direction, and the processing unit computing the Q fourth disparity images based on the Pth first disparity image and the virtual disparity.

According to an embodiment of the invention, each of the Q fourth disparity images comprises a plurality of valid pixels and a plurality of holes. The generation method of the invention further includes the processing unit generating an image processing window including at least one part of the plurality of valid pixels and at least one part of the plurality of holes, and the processing unit filling the at least one part of the plurality of holes based on the at least one part of the plurality of valid pixels. The at least one part of the plurality of valid pixels is beside the at least one part of the plurality of holes, and the at least one part of the plurality of holes is adjacent to a window edge of the image processing window.

According to an embodiment of the invention, the generation method of the invention further includes the processing unit segmenting the first view into a first view strip set along a segmenting direction obliquely intersecting an edge of the first view, the processing unit respectively segmenting the N first disparity images into N first disparity image strip sets along the segmenting direction, the processing unit respectively segmenting the M second disparity images into M second disparity image strip sets along the segmenting direction, the processing unit respectively segmenting the P third disparity images into P third disparity image strip sets along the segmenting direction, the processing unit respectively segmenting the Q fourth disparity images into Q fourth disparity image strip sets along the segmenting direction, and the processing unit interlacing the first view strip set, the N first disparity image strip sets, the M second disparity image strip sets, the P third disparity image strip sets, and the Q fourth disparity image strip sets for rendering a display image.

According to an embodiment of the invention, the generation method of the invention further includes the processing unit computing a depth of the first disparity map by analyzing the first disparity map, and the processing unit normalizing the depth with respect to a depth displaying allowance of a display device for allowing the depth of the first disparity map to be compatible with the depth displaying allowance of the display device.

The invention further discloses a displaying method for a multi-view auto-stereoscopic image which includes providing a first disparity image and at least one second disparity image, a processing unit segmenting the first disparity image into a first disparity image strip set along a segmenting direction obliquely intersecting an edge of the first disparity image, the processing unit segmenting the at least one second disparity image into at least one second disparity image strip set along the segmenting direction, the processing unit interlacing the first disparity image strip set and the at least one second disparity image strip set for rendering a display image, and the processing unit controlling a display device to display the display image. The segmenting direction is decomposed into a first component along a first direction and a second component along a second direction perpendicular to the first direction, and each of the first component and the second component is greater than zero. The display device has a portrait displaying mode and a landscape displaying mode. The segmenting direction includes a portrait direction and a landscape direction substantially perpendicular to the portrait direction. When the display device displays the display image at the portrait displaying mode, the processing unit segments the first disparity image and the at least one second disparity image along the portrait direction. When the display device displays the display image at the landscape displaying mode, the processing unit segments the first disparity image and the at least one second disparity image along the landscape direction.

According to an embodiment of the invention, the displaying method of the invention further includes providing an oblique lenticular lens layer including a plurality of oblique lenticular lenses, and disposing the oblique lenticular lens layer on the display device with the orientation of each of the plurality of oblique lenticular lenses substantially parallel to the segmenting direction. An orientation of each of the plurality of oblique lenticular lenses obliquely intersects an edge of the oblique lenticular lens layer.

The invention further discloses an electronic apparatus which includes a display device for displaying a display image, and an oblique lenticular lens layer disposed on the display device and including a plurality of oblique lenticular lenses. The display image is a multi-view auto-stereoscopic image, and the display image includes a first disparity image strip set and at least one second disparity image strip set. The first disparity image strip set and the at least one second disparity image strip set obliquely intersect an edge of the display image. An orientation of each of the plurality of oblique lenticular lenses obliquely intersects an edge of the oblique lenticular lens layer. An orientation of the first disparity image strip set and an orientation of the at least one second disparity image strip set being substantially parallel to the orientation of each of the plurality of oblique lenticular lenses. The display device has a portrait displaying mode and a landscape displaying mode. When the display device displays the display image at the portrait displaying mode, the orientation of the first disparity image strip set and the orientation of the at least one second disparity image strip set are substantially parallel to a portrait direction. When the display device displays the display image at the landscape displaying mode, the orientation of the first disparity image strip set and the orientation of the at least one second disparity image strip set are substantially parallel to a landscape direction. The portrait direction is substantially perpendicular to the landscape direction.

According to the generation method for a multi-view auto-stereoscopic image of the invention, after disparity information has been computed based on the raw first view and second view, all raw information other than the first view can be disregarded and only the first view and the computed disparity information are required to render a plurality of disparity images via recursive algorithm for fusing the multi-view auto-stereoscopic image. That is, the generation method requires only a pair of image capturing devices capturing views for computing the disparity information and further requires only one of the captured views for fusing the stereoscopic image, which provides convenience in photographing since the disparity information is allowed to adopt a reasonable rendering direction that is independent of the installation orientation of the image capturing device. Therefore, the invention not only saves equipment cost and image-processing time but also improves convenience in photographing. Besides, the electronic apparatus with the generation method and the displaying method of the invention can obliquely segment an image for interlacing, and an interlaced image can be displayed on the display device with the compatible oblique lenticular lens layer. Therefore, by utilizing the generation method and the displaying method, the display device of the electronic apparatus can be disposed at arbitrary installation orientation including the portrait displaying mode and the landscape displaying mode to effectively present the stereoscopic image, which greatly improves utility of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic apparatus for capturing and displaying an image according to an embodiment of the invention.

FIG. 2 is a diagram of a first view and a second view according to the embodiment of the invention.

FIG. 3 is a diagram of a first disparity map according to the embodiment of the invention.

FIG. 4 is a diagram illustrating a generation method for a first disparity image and a second disparity image according to the embodiment of the invention.

FIG. 5 is a diagram illustrating the generation method for the N first disparity images and the M second disparity images according to the embodiment of the invention.

FIG. 6 is a diagram illustrating a generation method for the N first disparity images, the M second disparity images, the P third disparity images, and the Q fourth disparity images according to another embodiment of the invention.

FIG. 7 is a diagram illustrating the disparity images shown in FIG. 6 in a sequence according to another embodiment of the invention.

FIG. 8 is a diagram illustrating the disparity images shown in FIG. 7 being interlaced according to another embodiment of the invention.

FIG. 9 is a diagram of disocclusion area present in the disparity image according to the embodiment of the invention.

FIG. 10 is a diagram illustrating the generation method filling the disocclusion area according to the embodiment of the invention.

FIG. 11 is a diagram illustrating normalization of a depth of an image according to the embodiment of the invention.

FIG. 12 is a diagram of the electronic apparatus displaying a display image according to the embodiment of the invention.

FIG. 13A is a diagram of the oblique lenticular lens layer according to the embodiment of the invention.

FIG. 13B is a sectional diagram of the oblique lenticular lens layer according to the embodiment of the invention.

FIG. 14 is a diagram of a display device displaying the display image at a landscape displaying mode according to the embodiment of the invention.

FIG. 15 is a diagram of the display device displaying the display image at a portrait displaying mode according to the embodiment of the invention.

FIG. 16 is a diagram illustrating that a portrait direction and a landscape direction of the display device are perpendicular to each other according to the embodiment of the invention.

FIG. 17 is a flow diagram illustrating the generation method for N first disparity images according to the embodiment of the invention.

FIG. 18 is a flow diagram illustrating the generation method for the M second disparity images and an interlaced image according to the embodiment of the invention.

FIG. 19 is a diagram illustrating the generation method for P third disparity images and Q fourth disparity images and an interlaced image according to another embodiment of the invention.

FIG. 20 is a flow diagram illustrating how the displaying method interlaces the first disparity image and the second disparity image according to the embodiment of the invention.

### DETAILED DESCRIPTION

Certain terms are used throughout the following description and claims to refer to particular system components. As one skilled in the art will appreciate, manufacturers may refer to a component by different names. In the following discussion and claims, the system components are differentiated not by their names but by their function and structure differences. In the following discussion and claims, the terms “include” and “comprise” are used in an open-ended fashion and should be interpreted as “include but is not limited to”. Also, the term “couple” or “link” is intended to mean either an indirect or a direct mechanical or electrical connection. Thus, if a first device is coupled or linked to a second device, that connection may be through a direct mechanical or electrical connection, or through an indirect mechanical or electrical connection via other devices and connections.

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

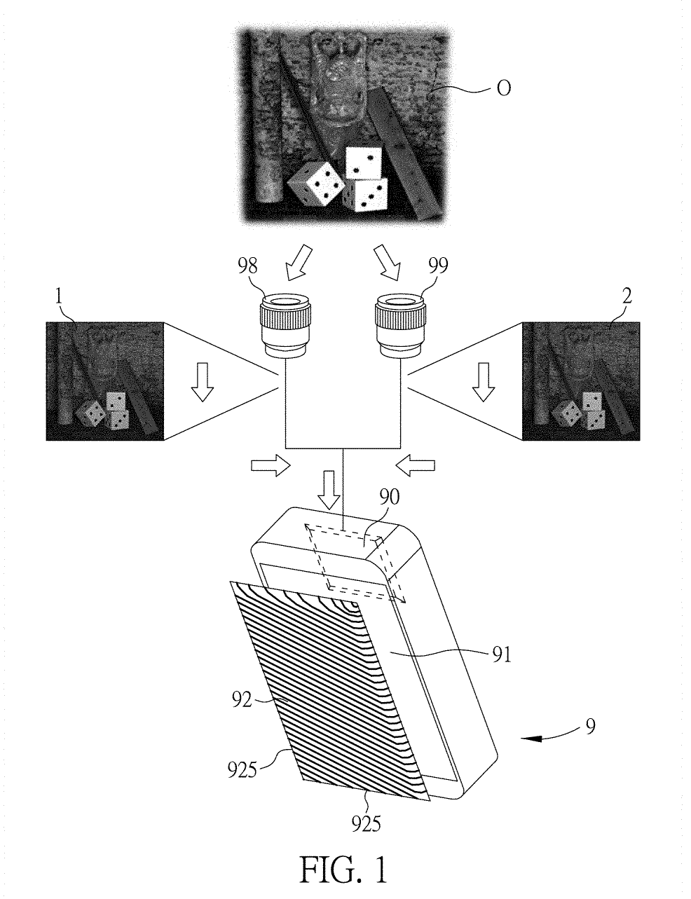

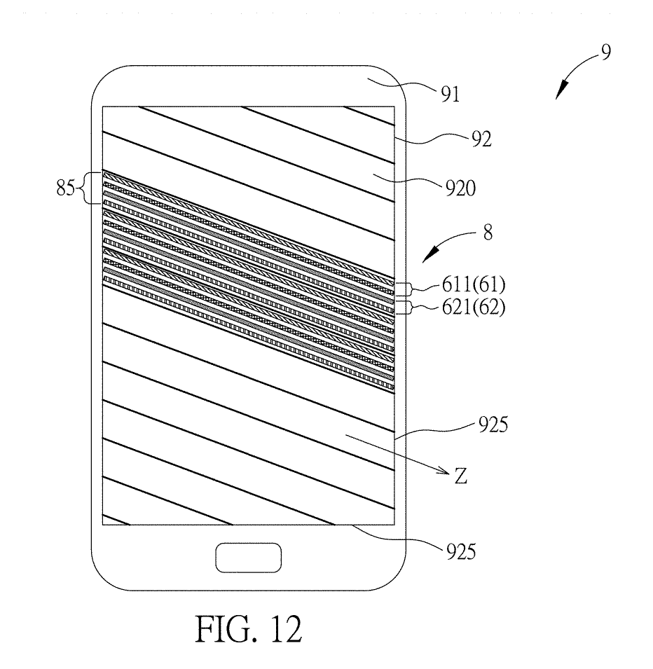

Please refer to FIG. 1 and FIG. 12. FIG. 1 is a diagram of an electronic apparatus 9 for capturing and displaying an image according to an embodiment of the present application. FIG. 12 is a diagram of the electronic apparatus 9 displaying a display image 8 according to the embodiment of the present application. The invention discloses the electronic apparatus 9 which includes a display device 91 for displaying the display image 8, and an oblique lenticular lens layer 92 disposed on the display device 91 and including a plurality of oblique lenticular lenses 920. The display image 8 includes at least one first disparity image strip set 61 and at least one second disparity image strip set 62. The at least one first disparity image strip set 61 includes a plurality of first disparity image strips 611, and the at least one second disparity image strip set 62 includes a plurality of second disparity image strips 621. The plurality of first disparity image strips 611 and the plurality of second disparity image strips 621 are interlaced with one another, so as to render the display image 8. The at least one first disparity image strip set 61 and the at least one second disparity image strip set 62 obliquely intersect an edge 85 of the display image 8. An orientation Z of each of the plurality of oblique lenticular lenses 920 obliquely intersects an edge 925 of the oblique lenticular lens layer 92. It should be noticed that the display image 8 can be a multi-view auto-stereoscopic image, but the invention is not limited thereto.

As shown in FIG. 1, the electronic apparatus 9 further includes a first image capturing device 98, a second image capturing device 99, and a processing unit 90. The processing unit 90 is coupled to the first image capturing device 98 and the second image capturing device 99. The first image capturing device 98 and the second image capturing device 99 capture the first view 1 and the second view 2 of an object O, respectively. Therefore, the processing unit 90 renders a multi-view auto-stereoscopic image based on the first view 1 captured by the first image capturing device 98 and the second view 2 captured by the second image capturing device 99.

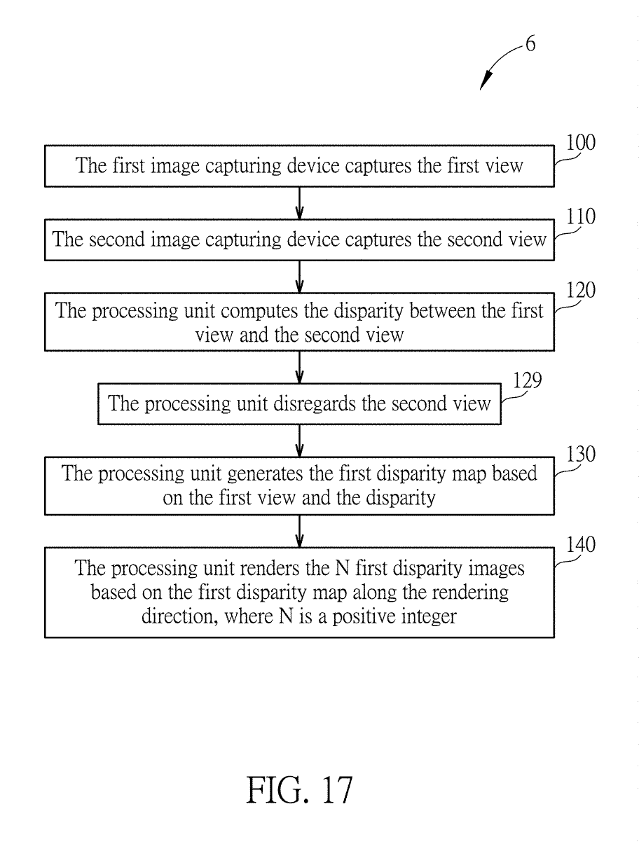

Please refer to FIG. 1 and FIG. 17. FIG. 17 is a flow diagram illustrating a generation method 6 for N first disparity images 11 according to the embodiment of the invention. The invention further discloses the generation method 6 for the multi-view auto-stereoscopic image. As shown in FIG. 17, the detailed generation method 6 for the N first disparity images 11 includes the following steps:

Step 100: the first image capturing device 98 capturing the first view 1;

Step 110: the second image capturing device 99 capturing the second view 2;

Step 120: the processing unit 90 computing a disparity D0 between the first view 1 and the second view 2;

Step 129: the processing unit 90 disregarding the second view 2;

Step 130: the processing unit 90 generating a first disparity map 3 based on the first view 1 and the disparity D0;

Step 140: the processing unit 90 rendering N first disparity images 11 based on the first disparity map 3 along a rendering direction X1, where N is a positive integer.

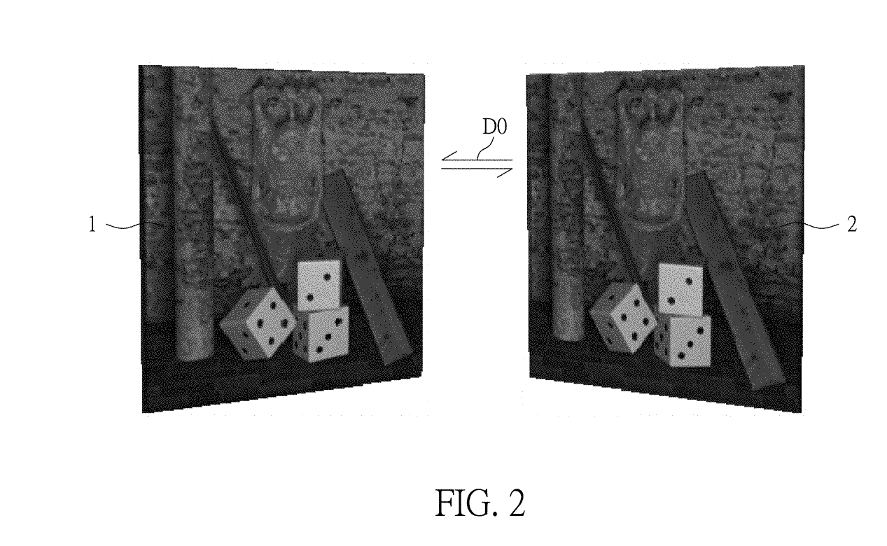

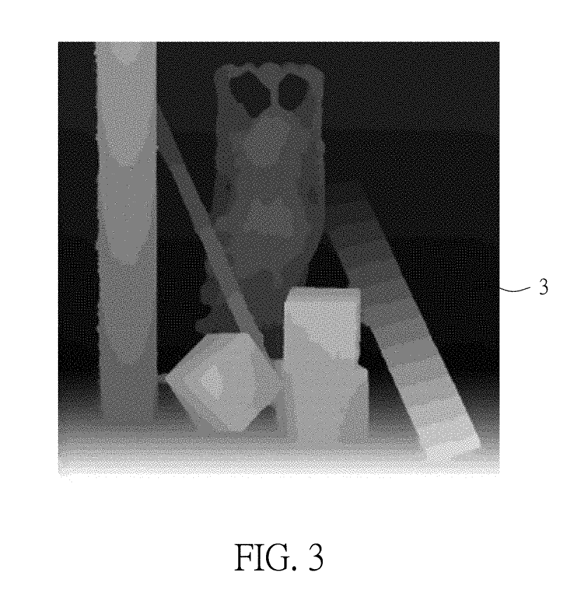

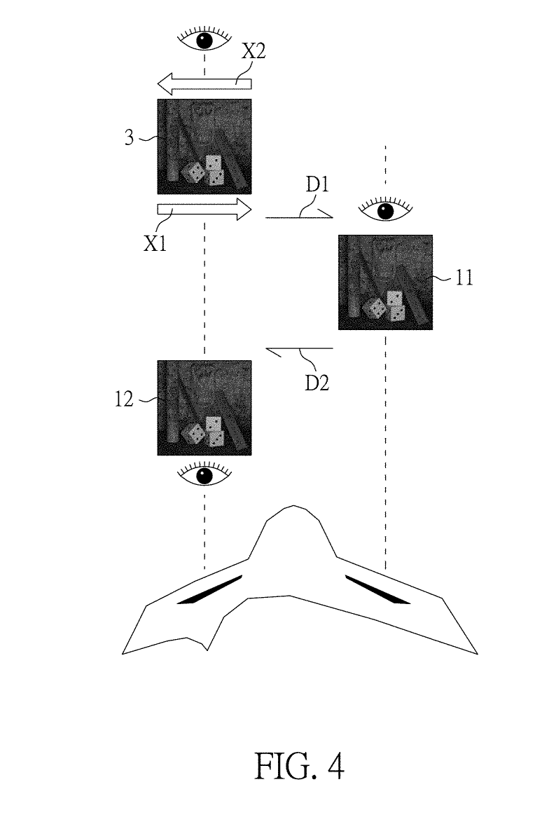

Please refer to FIG. 1 to FIG. 4 and FIG. 17. FIG. 2 is a diagram of a first view 1 and a second view 2. FIG. 3 is a diagram of a first disparity map 3 according to the embodiment of the invention. FIG. 4 is a diagram illustrating the generation method 6 for a first disparity image 11 and a second disparity image 12 according to the embodiment of the invention. Detailed description for the generation method 6 for the N first disparity images 11 is described as follows. First, as shown in FIG. 1, the first image capturing device 98 and the second image capturing device 99 are set beside each other, and the first image capturing device 98 and the second image capturing device 99 respectively capture the first view 1 of the object O and the second view 2 of the object O simultaneously (Step 100 and Step 110). The first image capturing device 98 and the second image capturing device 99 can be externally connected with the electronic apparatus 9, but the invention is not limited thereto. In another embodiment, the first image capturing device 98 and the second image capturing device 99 can be disposed on a surface of the electronic apparatus 9, like a dual-lens camera on a facade of a mobile phone. The first image capturing device 98 and the second image capturing device 99 are spaced apart, which resembles the human eyes being spaced apart, and the first image capturing device 98 and the second image capturing device 99 can be regarded as viewing the single object O from different viewpoints (also called visual angles or angles of vision). Therefore, by resembling perceiving the object O with the human's right eye and left eye respectively, the first view 1 captured by the first image capturing device 98 differs from the second view 2 captured by the second image capturing device 99 by a disparity D0 in field of view (also called parallax), as shown in FIG. 2.

Next, the processing unit 90 computes the disparity D0 based on the difference between the first view 1 and the second view 2 (Step 120) and then generates the first disparity map 3 (as shown in FIG. 3) which is equal in size to the first view 1 and indicates values of the disparity D0 in response to pixels of the first disparity map (Step 130). As shown in FIG. 3, the first disparity map 3 is a gray-scale image, wherein different values of the disparity D0 at different pixels corresponds to different gray levels so that the different values of the disparity D0 can be explicitly illustrated in form of light and shade in the first disparity map 3. It should be noticed that, in another embodiment, the first disparity map 3 can be a matrix that stores the different values of the disparity D0, and the description of the exemplary embodiments is intended to be illustrative and not to limit the scope of the invention.

After the first disparity map 3 is generated, the processing unit 90 computes the N first disparity images 11 based on the first disparity map 3 along the rendering direction X1, wherein N is a positive integer (Step 140). The processing unit 90 only requires the first view 1 and the disparity D0 for generating the first disparity map 3 and subsequent disparity images, such as the N first disparity images 11. As a result, the second view 2 and any information related with the second view 2 can be disregarded (Step 129) after the disparity D0 is computed. In practical application, after the disparity D0 is computed, the processing unit 90 can perform subsequent algorithm without using the second view 2 and any information related to the second view 2.

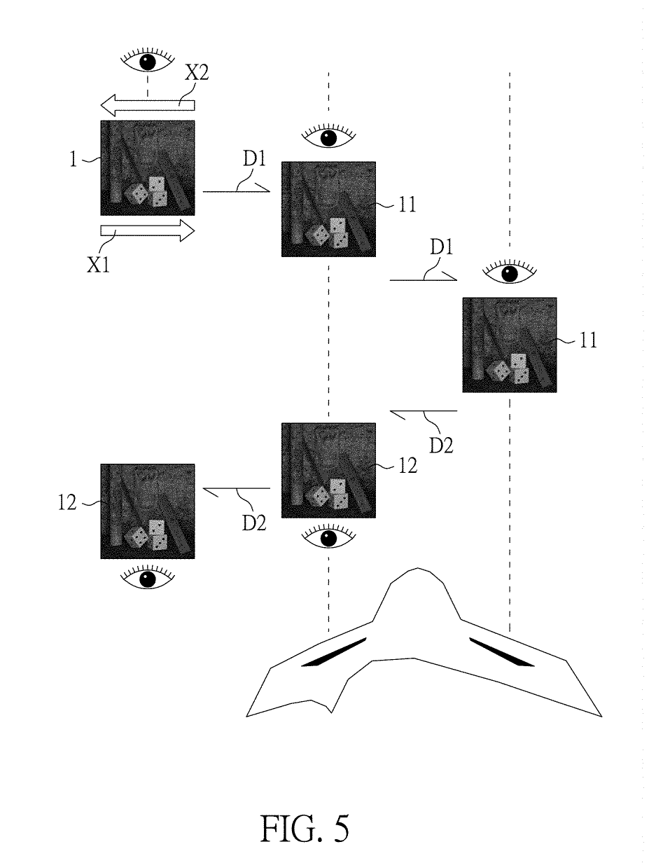

Please refer to FIG. 4 and FIG. 5. FIG. 5 is a diagram illustrating the generation method 6 for the N first disparity images and the M second disparity images according to the embodiment of the invention. It should be noticed that the processing unit 90 can compute a virtual disparity D1 along the rendering direction X1 based on the generated first disparity map 3, but the invention is not limited thereto. In practical application, the virtual disparity D1 can be a default value set according to human factors parameters, such as the averaged spacing between human eyes and the optimum viewing distance (OVD) from a user to the display device 91, and the set virtual disparity D1 can further be adjusted according to the user's demand. The processing unit 90 applies the virtual disparity D1 to the first disparity map 3 (or the first view 1) for rendering the first one of N first disparity images 11. That is, the virtual disparity D1 can be regarded as a natural disparity (or parallax) between the first disparity map (or the first view 1) and the first one of the N first disparity images 11, which means that the first disparity map 3 (or the first view 1) and the first one of the N first disparity images 11 can be respectively regarded as views viewed by the human's right eye and left eye, as shown in FIG. 4 and FIG. 5.

Repeating the abovementioned process, the processing unit 90 applies the virtual disparity D1 to the first one of the N first disparity images 11 for rendering the second one of the N first disparity images 11 and then applies the virtual disparity D1 to the second one of the N first disparity images 11 for rendering the third one of the N first disparity images 11 and so on until the Nth one of the N first disparity images 11 is rendered. The Nth one of the N first disparity images 11 can be regarded as a terminal image along the rendering direction X1 starting from the first disparity map 3 (or the first view 1). As shown in FIG. 4 and FIG. 5, when N equals one, the first one of the N first disparity images 11 is the terminal image along the rendering direction X1. When N equals two, the second one of the N first disparity images 11 is the terminal image, etc.

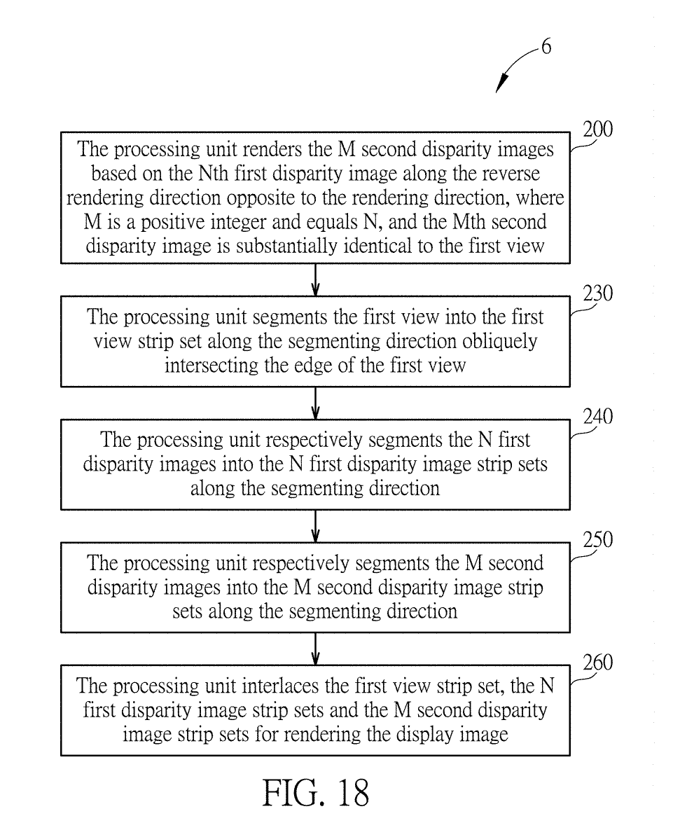

Please refer to GIG. 18. FIG. 18 is a flow diagram illustrating the generation method 6 for the M second disparity images 12 and an interlaced image according to the embodiment of the invention. As shown in FIG. 18, the detailed generation method 6 for the M second disparity images 12 and a detailed procedure of interlacing include the following steps:

Step 200: the processing unit 90 rendering the M second disparity images 12 based on the Nth first disparity image 11 along a reverse rendering direction X2 opposite to the rendering direction X1, where M is a positive integer and equals N, and the Mth second disparity image 12 is substantially identical to the first view 1;

Step 230: the processing unit 90 segmenting the first view 1 into a first view strip set 19 along a segmenting direction Y obliquely intersecting an edge 15 of the first view 1;

Step 240: the processing unit 90 respectively segmenting the N first disparity images 11 into N first disparity image strip sets 61 along the segmenting direction Y;

Step 250: the processing unit 90 respectively segmenting the M second disparity images 12 into M second disparity image strip sets 62 along the segmenting direction Y;

Step 260: the processing unit 90 interlacing the first view strip set 19, the N first disparity image strip sets 61 and the M second disparity image strip sets 62 for rendering a display image 8.

Please refer to FIG. 4 and FIG. 5. Detailed description of the generation method 6 for the M second disparity images 12 is described as follows. After the N first disparity images 11 are generated, the processing unit 90 computes the M second disparity images 12 based on the N first disparity images 11 along the reverse rendering direction X2 opposite to the rendering direction X1. The M is an integer that equals N, and the Mth second disparity image 12 is substantially identical to the first view 1 (Step 200). Based on a recursive algorithm adopted by the generation method 6 of the present invention, the processing unit 6 computes a reverse virtual disparity D2 along the reverse rendering direction X2. The reverse virtual disparity D2 can be regarded as a default value with equivalent function as the virtual disparity D1 but with a direction opposite to the virtual disparity D1, which is not illustrated here for the sake of simplicity. The processing unit 90 applies the computed reverse virtual disparity D2 to the Nth of the N first disparity images 11 for generating the first of the M second disparity images 11 and subsequently generates the second of the M second disparity images 12, the third of the M second disparity images 12, and so on by repeating the aforementioned process until the Mth of the M second disparity images 12 is generated. The process of how the processing unit 90 computes the N first disparity images 11 based on the first disparity map 3 (or the first view 1) and the process of how the processing unit 90 computes the M second disparity images 12 based on the Nth of the N first disparity images 11 mainly differ in adopting opposite rendering directions but have identical computing principles, which is not illustrated here for the sake of simplicity.

It should be noticed that the virtual disparity D2 is opposite in direction to the virtual direction D1. Therefore, if the N-1th and the Nth of the N first disparity images 11 are respectively regarded as views viewed by the human's left and right eyes, the Nth of the N first disparity images 11 and the first of the M second disparity images 12 can be regarded as views viewed by the human's right and left eyes, as shown in FIG. 4 and FIG. 5. That is, the N first disparity images 11 and the M second disparity images 12 are computed along opposite directions, as shown in FIG. 4 and FIG. 5. Based on the recursive algorithm adopted by the generation method 6 of the invention, the N first disparity images 11 are identical in number to the M second disparity images 12 (N=M). That is, there can be substantially no disparity between the Mth one of the M second disparity images 12 and the first disparity map 3 (or the first view 1), and the Mth one of the M second disparity images 12 is substantially identical to the first disparity map 3 (or the first view 1). As shown in FIG. 4 and FIG. 5, when N=M=1, the first one of the M second disparity images 12 is substantially identical to the first view 1; When N=M=2, the second one of the M second disparity images 12 is substantially identical to the first view 1, etc. Besides, since the Mth one of the M second disparity images 12 is substantially identical to the first disparity map 3 (or the first view 1), thereby the recursive algorithm can be regarded as completed after the Mth one of the M second disparity images 12 is rendered. That is, according to the embodiment of the invention, the abovementioned rendering process from the first disparity map 3 (or the first view 1) to the Mth of the M second disparity images 12 can be regarded as a cycle of the recursive algorithm, and the rendering process for the N+M disparity images can be regarded as a unilateral recursive algorithm.

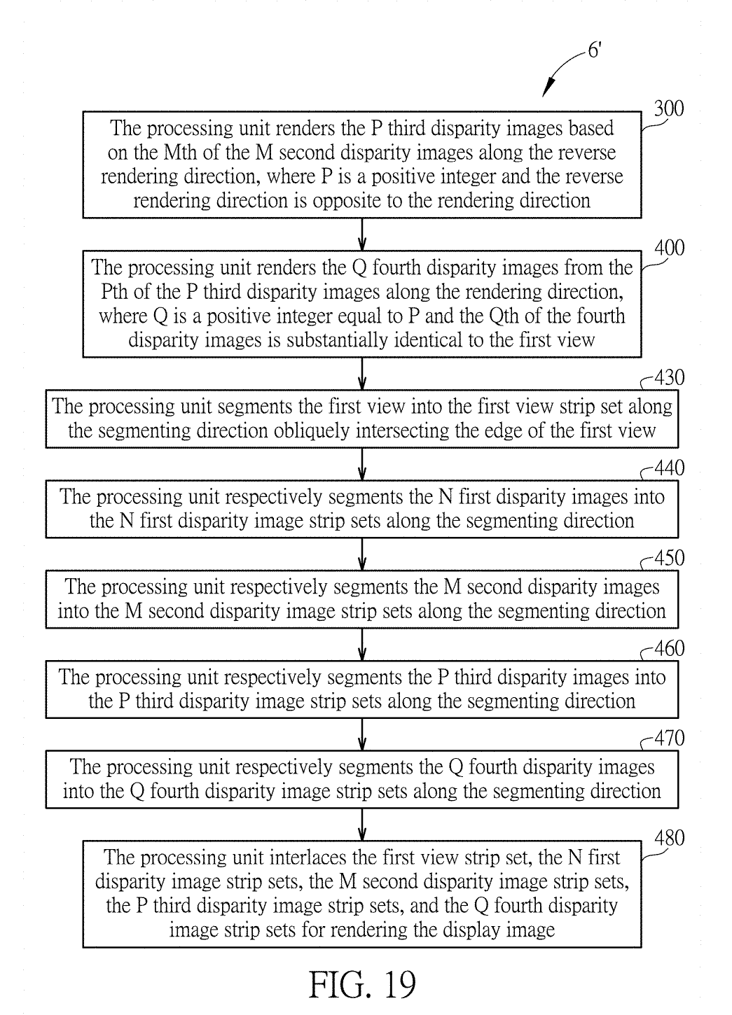

Please refer to FIG. 19. FIG. 19 is a diagram illustrating a generation method 6′ for P third disparity images 13 and Q fourth disparity images 14 and an interlaced image according to another embodiment of the invention. The detailed generation method 6′ for the P third disparity images 13, the Q fourth disparity images 14, and the interlaced image includes the following steps:

Step 300: the processing unit 90 rendering the P third disparity images 13 based on the Mth of the M second disparity images 12 along the reverse rendering direction X2, where P is a positive integer and the reverse rendering direction X2 is opposite to the rendering direction X1;

Step 400: the processing unit 90 rendering Q fourth disparity images 14 from the Pth of the P third disparity images 13 along the rendering direction X1, where Q is a positive integer equal to P and the Qth of the fourth disparity images 14 is substantially identical to the first view 1;

Step 430: the processing unit 90 segmenting the first view 1 into a first view strip set 19 along a segmenting direction Y obliquely intersecting an edge 15 of the first view 1;

Step 440: the processing unit 90 respectively segmenting the N first disparity images 11 into N first disparity image strip sets 61 along the segmenting direction Y;

Step 450: the processing unit 90 respectively segmenting the M second disparity images 12 into M second disparity image strip sets 62 along the segmenting direction Y;

Step 460: the processing unit 90 respectively segmenting the P third disparity images 13 into P third disparity image strip sets 63 along the segmenting direction Y;

Step 470: the processing unit 90 respectively segmenting the Q fourth disparity images 14 into Q fourth disparity image strip sets 64 along the segmenting direction Y;

Step 480: the processing unit 90 interlacing the first view strip set 19, the N first disparity image strip sets 61, the M second disparity image strip sets 62, the P third disparity image strip sets 63, and the Q fourth disparity image strip sets 64 for rendering a display image 8.

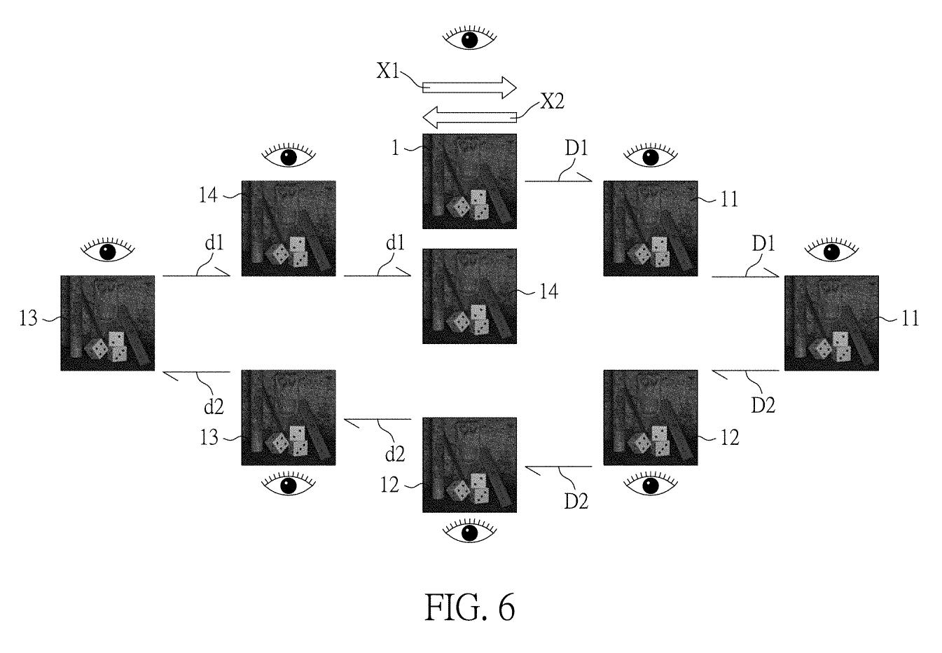

Please refer to FIG. 6. FIG.6 is a diagram illustrating the generation method 6′ for the N first disparity images 11, the M second disparity images 12, the P third disparity images 13, and the Q fourth disparity images 14 according to the another embodiment of the invention. Detailed description for the generation method 6′ for the P third disparity images 13 and the Q fourth disparity images 14 after the M second disparity images 12 are rendered is described as follows. According to the embodiment, after rendering the M second disparity images 12, the generation method 6′ computes the P third disparity images 13 based on the Mth one of the M second disparity images 12 along the reverse rendering direction X2 (Step 300) and then computes the Q fourth disparity images 14 based on the Pth one of the P third disparity images 13 along the rendering direction X1 (Step 400). Q is a positive integer and equal to P, and the Qth one of the Q fourth disparity images 14 is substantially identical to the first view 1.

In the process of computing the P third disparity images 13, the processing unit 90 computes a reverse virtual disparity D2 along the reverse rendering direction X2 and applies the computed reverse virtual disparity D2 to the Mth one of the M second disparity images 12 for to sequentially render the P third disparity images 13. Next, the processing unit 90 computes a virtual disparity D1 along the rendering direction X1 and applies the computed virtual disparity D1 to the Pth one of the P third disparity images 13 to render the Q fourth disparity images 14. The process of generating the P+Q disparity images (as shown in FIG. 19) and the process of generating the M+N disparity images (as shown in FIG. 17 and FIG. 18) mainly differ in adopting opposite rendering directions but have identical rendering principles, which is not illustrated here for the sake of simplicity. It should be noticed that, the virtual disparity D1 can be regarded as identical to the virtual disparity D1, but the invention is not limited thereto. The reverse virtual disparity D2 can be regarded as identical to the reverse virtual disparity D2, but the invention is not limited thereto.

Since the Qth of the Q fourth disparity images 14 is substantially identical to the first disparity map 3 (or the first view 1), thereby the recursive algorithm can be regarded as completed after the Qth one of the Q fourth disparity images 14 is rendered. That is, according to the embodiment of the invention, the abovementioned rendering process from the Mth one of the M second disparity images 12 to the Qth one of the Q fourth disparity images 14 can be regarded as a cycle of the recursive algorithm, and the rendering process for the N+M+Q+P disparity images can be regarded as a bilateral recursive algorithm. The bilateral recursive algorithm and the unilateral recursive algorithm mainly differ in ranges of the fields of vision but both achieve stereoscopic effect, which is not illustrated here for the sake of simplicity. It should be noticed that the virtual disparity D1 and the reverse virtual disparity D2 adopted in the rendering process for P+Q disparity images can be different or identical in quantity to the virtual disparity D1 and the reverse virtual disparity D2 adopted in the rendering process for N+M disparity images, and P and Q can respectively be different or identical to M and N.

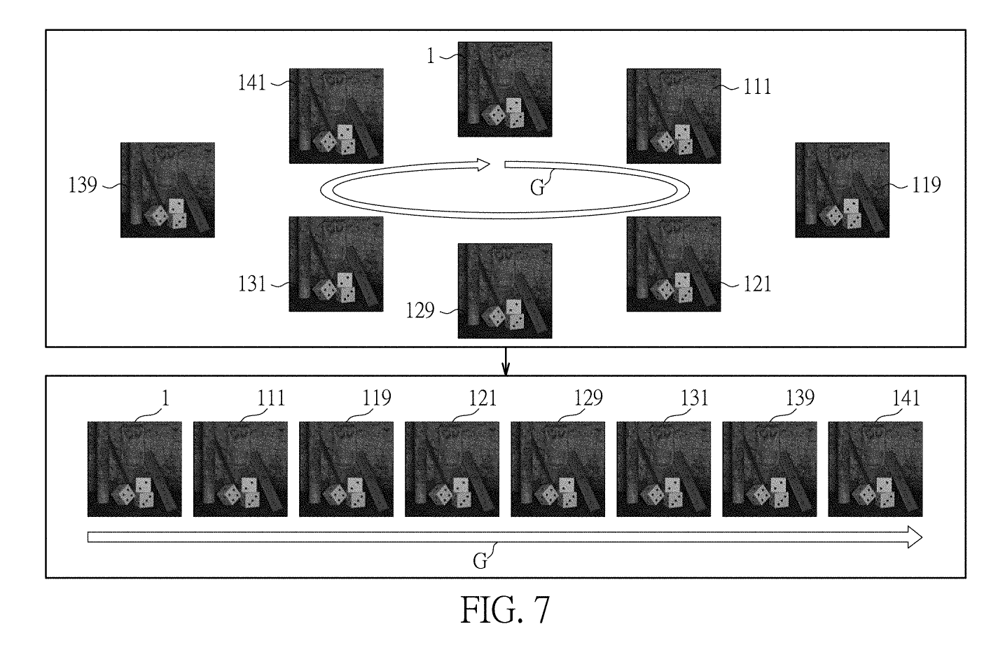

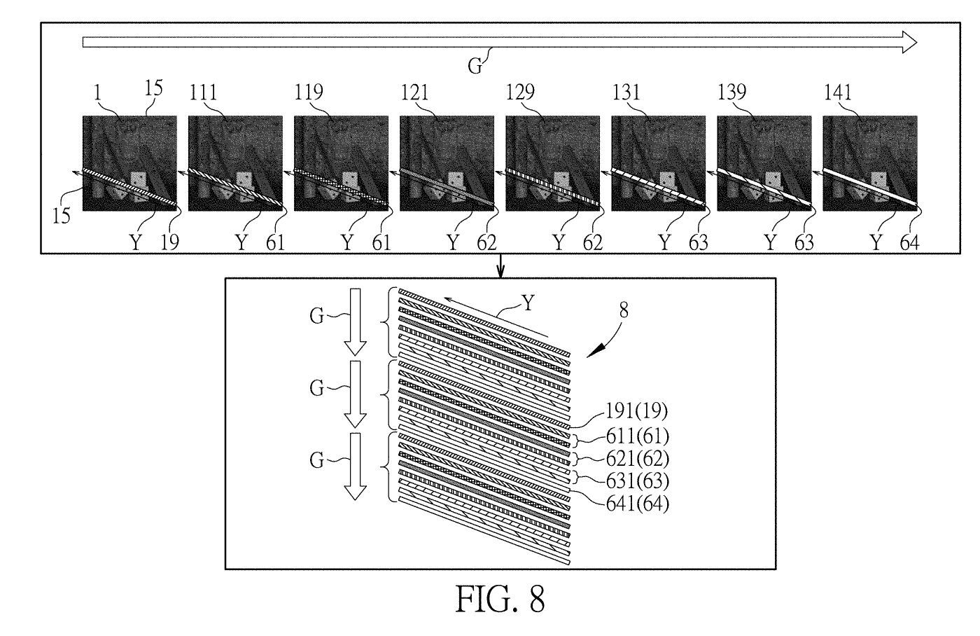

Please refer to FIG. 7, FIG. 8, FIG. 18, and FIG. 19. FIG. 7 is a diagram illustrating the disparity images shown in FIG. 6 in a sequence according to another embodiment of the invention. FIG. 8 is a diagram illustrating the disparity images shown in FIG. 7 being interlaced according to another embodiment of the invention. Detailed descriptions for how the generation method 6′ interlaces the N+M+P+Q disparity images is described as follows. After the N+M+P+Q disparity images are generated, the processing unit 90 linearly arranges the first view 1 and the N+M+P+Q disparity images according to the sequence of generation G along a direction from the left eye to the right eye. As shown in FIG. 7, when N=M=P=Q, the sequence of generation G of the N+M+P+Q disparity images are as follows: the first view 1 is followed by the first and the rest of the N first disparity images 111 sequentially arranged till the last of the N first disparity images 111, which is followed by the first and the rest of the M second disparity images 121 sequentially arranged till the last of the M second disparity images 121, which is followed by the first and the rest of the P third disparity images 131 sequentially arranged till the last of the P third disparity images 131, which is followed by the first and the rest of the Q fourth disparity images 141 sequentially arranged till the last of the Q fourth disparity images 141. It is noticed that since the last of the Q fourth disparity images 141 is substantially identical to the first view 1, the last of the Q fourth disparity images 141 is not shown in FIG. 7 for the sake of simplicity. The linear array of the N+M+P+Q disparity images in the aforementioned sequence of generation G is illustrated in FIG. 7, where N=M=P=Q=2 according to the embodiment shown in FIG. 7.

Next, as shown in FIG. 8, the processing unit 90 segments the first view 1 into a first view strip set 19 along a segmenting direction Y obliquely intersecting an edge 15 of the first view 1 (Step 230 and Step 240). The processing unit 90 respectively segments the N first disparity images 11 into N first disparity image strip sets 61 along the segmenting direction Y (Step 240 and Step 440). The processing unit 90 respectively segments the M second disparity images 12 into M second disparity image strip sets 62 along the segmenting direction Y (Step 250 and Step 450). The processing unit 90 respectively segments the P third disparity images 13 into P third disparity image strip sets 63 along the segmenting direction Y (Step 460). The processing unit 90 respectively segments the Q fourth disparity images 14 into Q fourth disparity image strip sets 64 along the segmenting direction Y (Step 470). After the N+M+P+Q disparity images are segmented, the processing unit 90 interlacing the first view strip set 19, the N first disparity image strip sets 61, the M second disparity image strip sets 62, the P third disparity image strip sets 63, and the Q fourth disparity image strip sets 64 for rendering a display image 8 (Step 480). The aforementioned interlacing step (Step 480) and the interlacing step (Step 260) that interlaces first view strip set 19, the N first disparity image strip sets 61 and the M second disparity image strip sets 62 for rendering a display image 8 are mainly differ in number of the disparity image strip sets but have identical algorithmic principle, which is not illustrated here for the sake of simplicity.

It should be noticed that the Qth one of the Q fourth disparity images 14 (also called the last one of the Q fourth disparity images 14) is substantially identical to the first view 1, and therefore the processing unit 90 can disregard the Qth one of the Q fourth disparity images 14 before interlacing step. That is, in practical interlacing step, the processing unit 90 adopts only Q−1 fourth disparity image strip sets to be interlaced with the other disparity image strip sets, but the invention is not limited thereto. In another embodiment, the processing unit 90 can replace the first view 1 with the Qth of the Q fourth disparity images 14 for interlacing. How image strip sets are interlaced to render a display image has been disclosed by conventional algorithmic principles, which is not illustrated here for the sake of simplicity. However, the image strip sets adopted by the conventional algorithmic principles are generated with segmentation direction parallel to an edge of each of the images, which are in contrast to the obliquely segmented image strip sets disclosed by the present application.

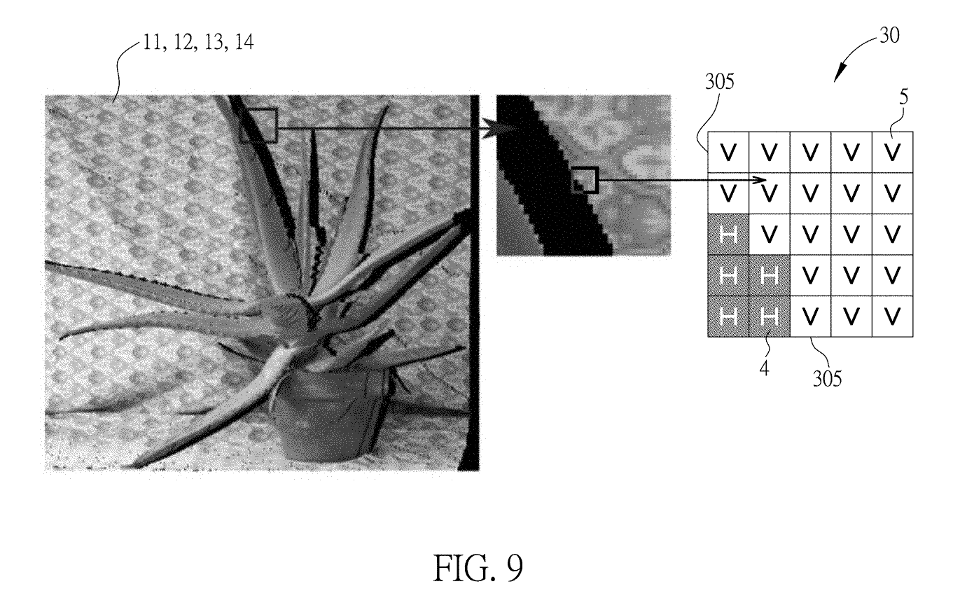

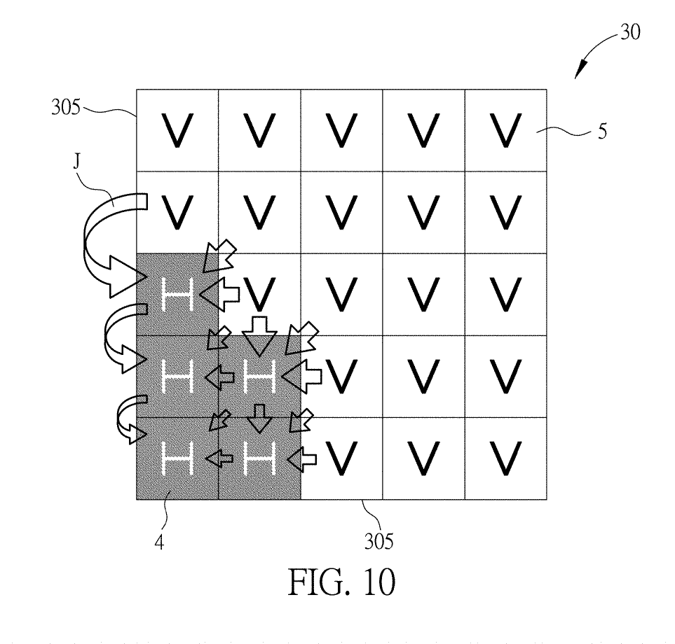

Please refer to FIG. 9 and FIG. 10. FIG. 9 is a diagram of disocclusion area present in the disparity image according to the embodiment of the invention. FIG. 10 is a diagram illustrating the generation method 6 filling the disocclusion area according to the embodiment of the invention. In the process of rendering a subsequent disparity image based on a prior disparity image, some of background information contained in the prior disparity image cannot be fused and presented in the subsequent disparity image, so there can be a plurality of holes 4 called disocclusion present in parts of the subsequent disparity image. If not processed, the plurality of holes 4 can lead to discontinuous display effect at the parts of the display image 8 correspondingly occupied by the plurality of holes 4. To solve the aforementioned problem, the processing unit 90 of the invention generates an image processing window 30 enclosing at least one part of a plurality of valid pixels 5 and at least one part of the plurality of holes 4, as shown in FIG. 9 and FIG. 10. The at least one part of the plurality of valid pixels 5 is aside the at least one part of the plurality of holes 4, and the at least one part of the plurality of holes 4 is adjacent to a window edge 305 of the image processing window 30. Thereby, the processing unit 90 can fill the at least one part of the plurality of holes 4 based on the at least one part of the plurality of valid pixels 5.

For example, the processing unit 90 can generate a mask (also called a computing matrix) of a particular size which covers at least one part of the disocclusion area. The mask can be a low-pass filter that smoothes the covered disocclusion area, such as through an averaging procedure, but not limited to this. In practical application, the processing unit 90 disposes the disocclusion area consisting of holes on an edge of the mask for performing hole-filling algorithm to generate a more realistic display effect. That is, by taking the hole with the most neighboring valid pixels as a target pixel, the processing unit 90 computes a value via the smoothing procedure performed on the valid pixels inside the mask and fills the target pixel with the computed value to convert the target pixel from a hole to a valid pixel. The valid pixel converted from the hole can be subsequently utilized as one of the inputs of the smoothing procedure for further filling a next hole, and so on. By repeating the aforementioned hole-filling algorithm, the entire disocclusion area can be gradually converted into valid pixels, starting from a side of the disocclusion area neighboring the valid pixels and proceeding towards an inside (or the other side) of the disocclusion area. Therefore, as illustrated by an arrow indicating a hole-filling sequence J in FIG. 10, the effect of the hole-filling algorithm can be viewed as if valid pixels can diffuse from a side of the disocclusion area towards the inside (or the other side) of the disocclusion area until the entire disocclusion area is occupied by valid pixels.

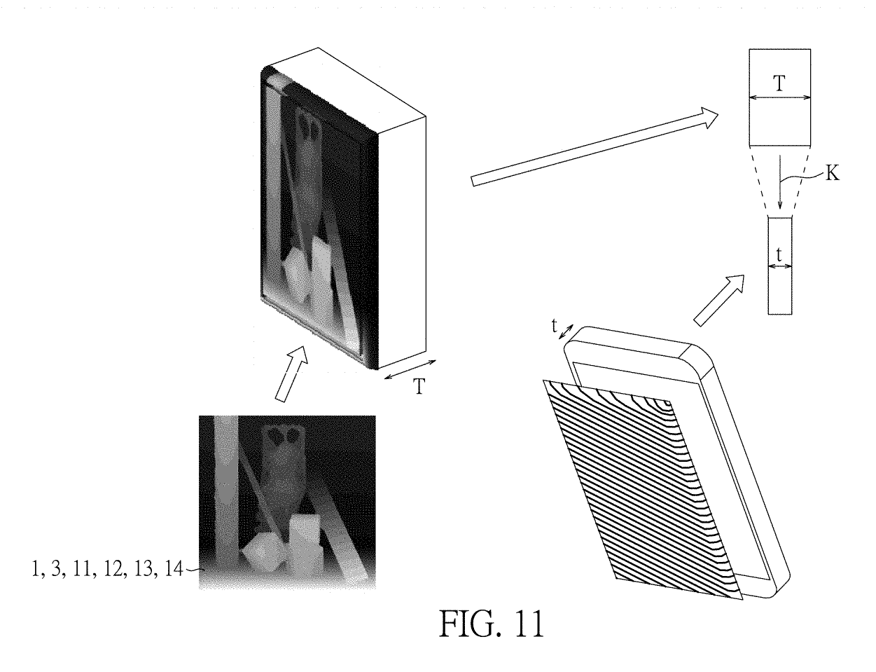

Please refer to FIG. 1 and FIG. 11. FIG. 11 is a diagram illustrating normalization of a depth T of an image according to the embodiment of the invention. Restricted by specification and structure of the display device 91, the display device 91 can only display the depth T of a particular range called a depth displaying allowance t of the display device 91. Besides, it is noticed that magnitude of disparity with respect to an object can vary with a distance between the object and the eyes, which means that disparity information substantially implies depth information and that the depth information can be extracted via analyzing the disparity information. Therefore, as shown in FIG. 11, the processing unit 90 of the invention computes a depth T of the first disparity map 3 by analyzing the first disparity map 3. Next, the processing unit 9 normalizes the depth T with respect to a depth displaying allowance t of a display device 91 for allowing the depth T of the first disparity map 3 to be compatible with the depth displaying allowance t of the display device 91.

Since the first disparity map 3 can be regarded as a diagram with function of indicating the disparity D0 based on the first view 1 (and the second view 2) and with substantially identical features and sizes to the first view 1, the depth T of the first view 1 can substantially be regarded as identical to a depth of the first disparity map 3. Besides, each of the disparity images is rendered by superimposing a virtual disparity value or a reverse virtual disparity value onto the base disparity value of the first disparity map 3 and superimposed disparity values do not affect relative depths between objects shown in each of the disparity images, so a depth of each of the disparity images is substantially identical to the depth T of the first disparity map 3. Therefore, a normalizing procedure K normalizing the depth T of the first disparity map 3 according to the depth displaying allowance t of the display device 91 can also be utilized by the processing unit 90 to normalize the depths of all the views and disparity images so that the depths of all the views and disparity images can be compatible with the depth displaying allowance t of the display device 91.

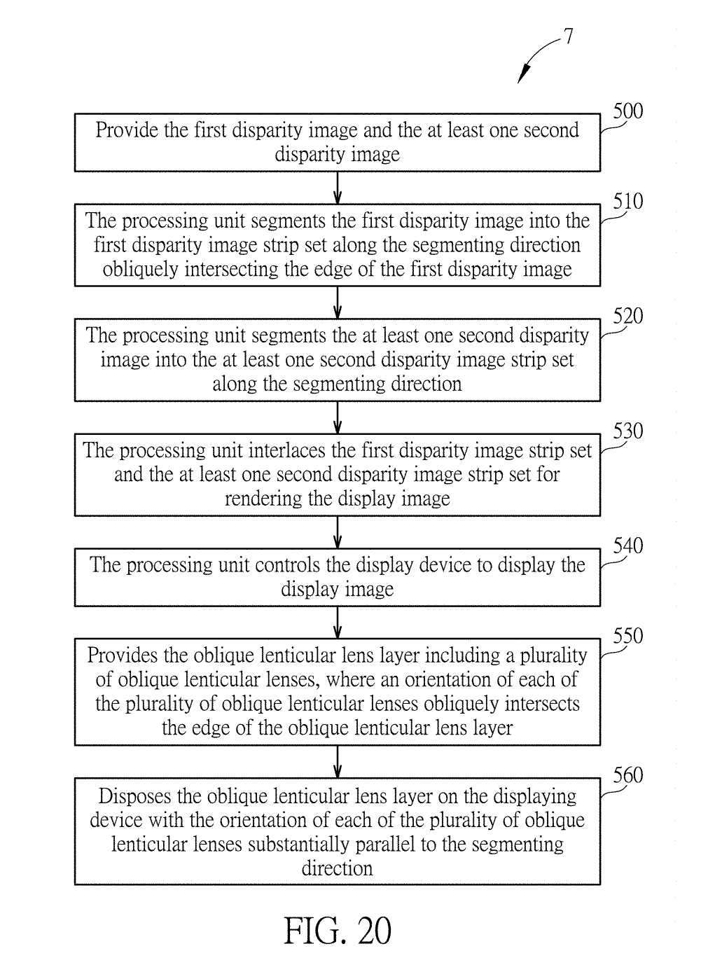

Please refer to FIG. 20. FIG. 20 is a flow diagram illustrating how the displaying method 7 interlaces the first disparity image 11 and the second disparity image 12 according to the embodiment of the invention. The invention further discloses a displaying method 7 for a multi-view auto-stereoscopic image. As shown in FIG. 20, the detail of how the displaying method 7 interlaces the first disparity images 11 and the second disparity images 12 to render the display image 8 includes the following steps:

Step 500: providing the first disparity image 11 and the at least one second disparity image 12;

Step 510: the processing unit 90 segmenting the first disparity image 11 into a first disparity image strip set 61 along a segmenting direction Y obliquely intersecting an edge 15 of the first disparity image 11;

Step 520: the processing unit 90 segmenting the at least one second disparity image 12 into at least one second disparity image strip set 62 along the segmenting direction Y;

Step 530: the processing unit 90 interlacing the first disparity image strip set 61 and the at least one second disparity image strip set 62 for rendering a display image 8;

Step 540: the processing unit 90 controlling a display device 91 to display the display image 8;

Step 550: providing an oblique lenticular lens layer 92 including a plurality of oblique lenticular lenses 920, an orientation Z of each of the plurality of oblique lenticular lenses 920 obliquely intersects an edge 925 of the oblique lenticular lens layer 92;

Step 560: disposing the oblique lenticular lens layer 92 on the displaying device 91 with the orientation Z of each of the plurality of oblique lenticular lenses 920 substantially parallel to the segmenting direction Y.

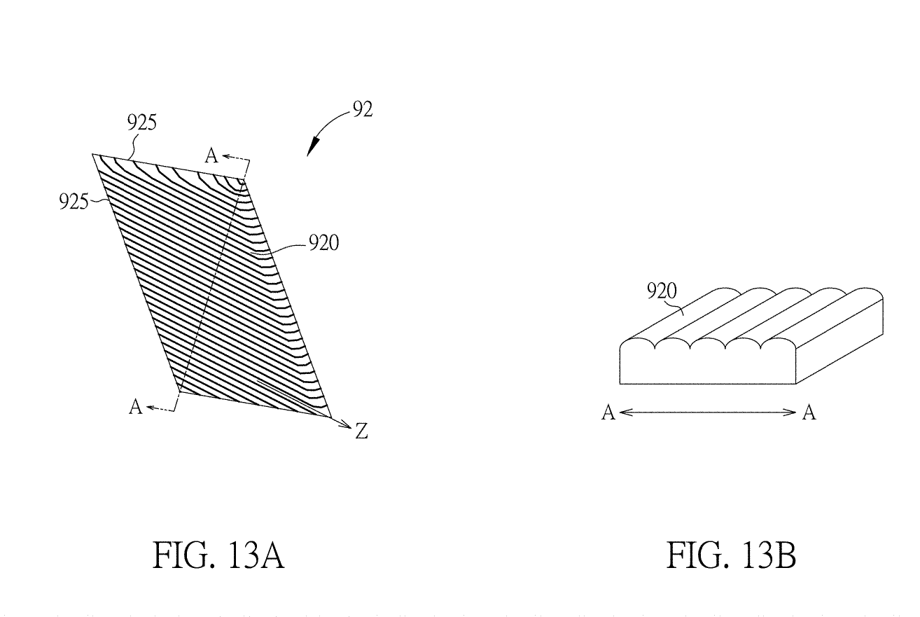

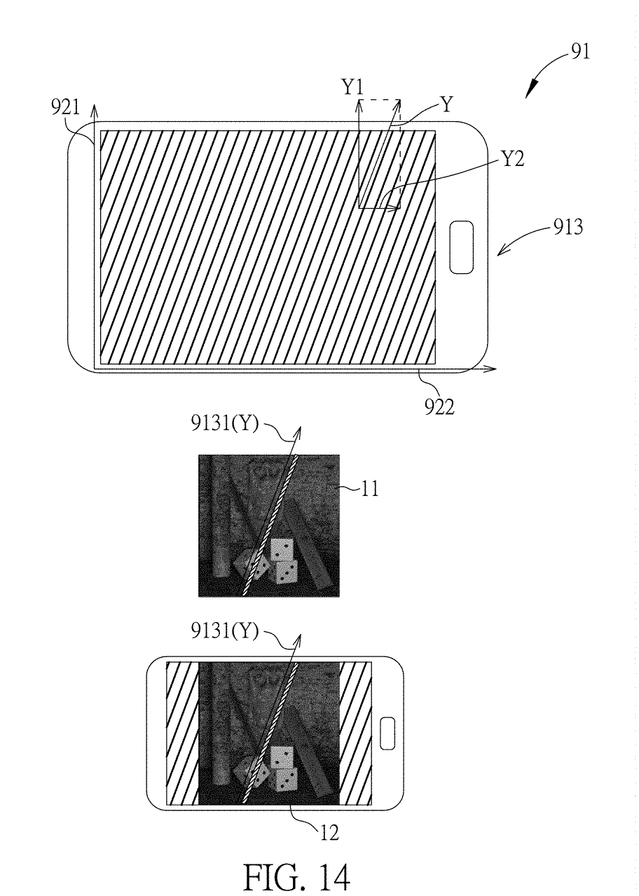

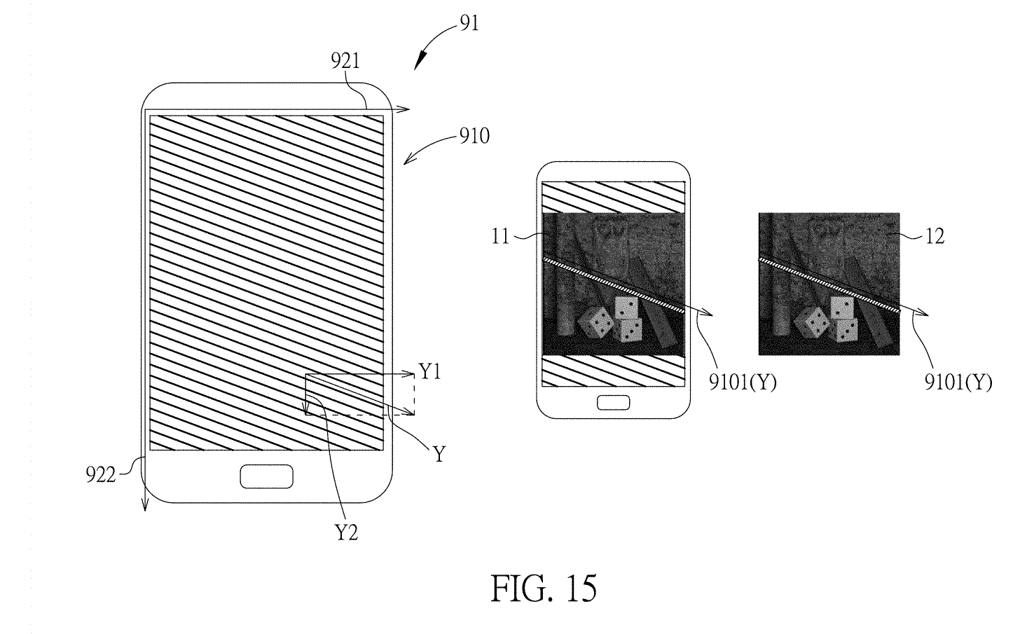

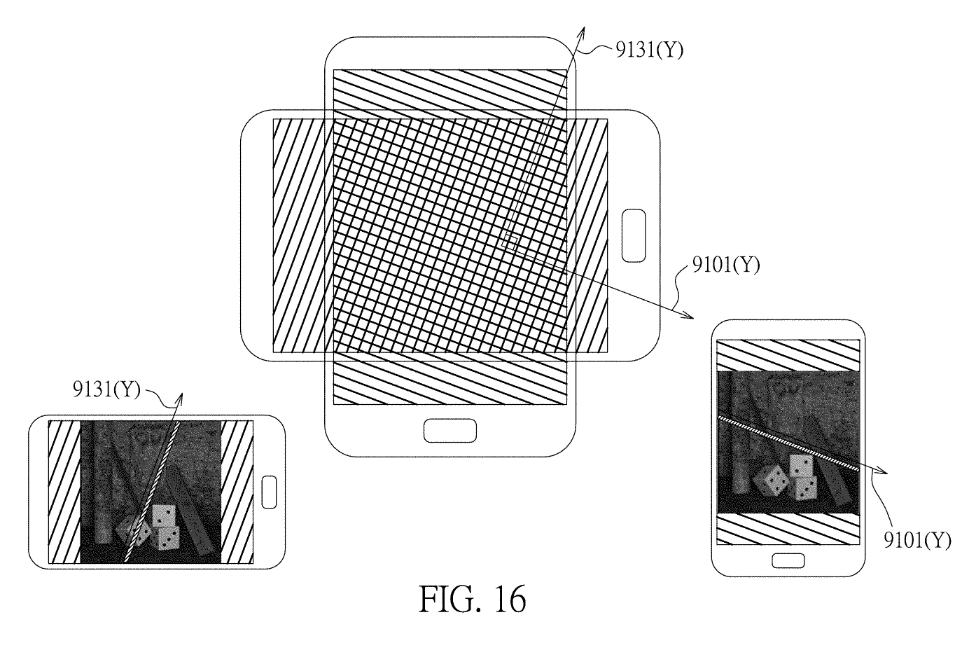

Please refer to FIG. 12 to FIG. 16 and FIG. 20. FIG. 13A is a diagram of the oblique lenticular lens layer 92 according to the embodiment of the invention, FIG. 13B is a sectional diagram of the oblique lenticular lens layer 92 according to the embodiment of the invention. FIG. 14 is a diagram of the display device 91 displaying the display image 8 at a landscape displaying mode according to the embodiment of the invention. FIG. 15 is a diagram of the display device 91 displaying the display image 8 at a portrait displaying mode according to the embodiment of the invention. FIG. 16 is a diagram illustrating that a portrait direction 9101 and a landscape direction 9131 of the display device 91 are perpendicular to each other according to the embodiment of the invention. Further detail of how the displaying method 7 generates the display image 8 based on the first disparity image 11 and the second disparity image 12 and displays the display image 8 on the displaying device 91 is described as follows. First, provide the first disparity image 11 and the second disparity image 12 with disparity therebetween to the processing unit 90 (Step 500). As described in the abovementioned paragraphs regarding the generation method 6, 6′ of the invention, the processing unit 90 can interlace at least two disparity images to render a display image 8, and here an interlacing procedure for only the first disparity images and the second disparity images is taken for example for the sake of simplicity. Therefore, the processing unit 90 can respectively segments the first disparity image 11 and the second disparity images 12 into the first disparity image strip set 61 and the second disparity image strip set 62 along the segmenting direction Y obliquely intersecting an edge 15 of the first disparity image 11 (Step 510 and Step 520).

Next, the processing unit 90 interlacing the first disparity image strip set 61 and the second disparity image strip set 62 for rendering the display image 8 (Step 530). As for how the displaying method 7 of the invention can segment and interlace the first disparity image and the second disparity image, please refer to the above paragraphs regarding the generation methods 6, 6′ and the electronic apparatus 9 for further illustration, which is not illustrated here for the sake of simplicity. After interlacing, the processing unit 90 controls a display device 91 to display the display image 8 (Step 540). By disposing the oblique lenticular lens layer 92 on the displaying device 91 (Step 550 and Step 560), the display device 91 can display an auto-stereoscopic image of the display image 8 through the oblique lenticular lens layer 92. The oblique lenticular lens layer 92 includes a plurality of oblique lenticular lenses 920, and an orientation Z of each of the plurality of oblique lenticular lenses 920 obliquely intersects an edge 925 of the oblique lenticular lens layer 92.

It should be noticed that the orientation Z of each of the plurality of oblique lenticular lenses 920 is substantially parallel to the segmenting direction Y. The segmenting direction Y can be decomposed into a first component Y1 along a first direction 921 and a second component Y2 along a second direction 922 perpendicular to the first direction 921, and each of the first component Y1 and the second component Y2 is greater than zero, as shown in FIG. 14 and FIG. 15. Since the display device 91 has a portrait displaying mode 910 and a landscape displaying mode 913, the segmenting direction Y can include (or be defined as) a portrait direction 9101 with respect to the portrait displaying mode 910 and can include (or be defined as) a landscape direction 9131 with respect to the landscape displaying mode 913, as shown in FIG. 14 and FIG. 15. The portrait direction 9101 is substantially perpendicular to the portrait direction. That is, when the displaying device 91 displays the display image 8 at the portrait displaying mode 910, the processing unit 90 segments the first disparity image 11 and the second disparity image 12 along the portrait direction 9101. When the displaying device 91 displays the display image at the landscape displaying mode 913, the processing unit 90 segments the first disparity image 11 and the second disparity image 12 along the landscape direction 9131. Since the processing unit segments the first disparity image 11 and the second disparity image 12 along the segmenting direction Y parallel to the orientation Z of each of the plurality of oblique lenticular lenses 920 and obliquely intersecting the edge of each of the disparity images, the first disparity image strip set 61 and the second disparity image strip set 62 of the display image 8 not only are parallel to the oblique lenticular lenses 920 but also obliquely intersect the edge of the display device 91 when the display image 8 is displayed on the display device 91.

According to the generation method for a multi-view auto-stereoscopic image of the invention, after disparity information has been computed based on the raw first view and second view, all raw information other than the first view can be disregarded and only the first view and the computed disparity information are required to render a plurality of disparity images via recursive algorithm for fusing the multi-view auto-stereoscopic image. That is, the generation method requires only a pair of image capturing devices capturing views for computing the disparity information and further requires only one of the captured views for fusing the stereoscopic image, which provides convenience in photographing since the disparity information is allowed to adopt a reasonable rendering direction that is independent of the installation orientation of the image capturing device. Therefore, the invention not only saves equipment cost and image-processing time but also improves convenience in photographing. Besides, the electronic apparatus with the generation method and the displaying method of the invention can obliquely segment an image for interlacing, and an interlaced image can be displayed on the display device with the compatible oblique lenticular lens layer. Therefore, by utilizing the generation method and the displaying method, the display device of the electronic apparatus can be disposed at arbitrary installation orientation including the portrait displaying mode and the landscape displaying mode to effectively present the stereoscopic image, which greatly improves utility of the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A generation method for a multi-view auto-stereoscopic image, comprising:
a first image capturing device capturing a first view;
a second image capturing device capturing a second view;
a processing unit computing a disparity between the first view and the second view;
the processing unit disregarding the second view;
the processing unit generating a first disparity map based on the first view and the disparity; and
the processing unit rendering N first disparity images based on the first disparity map along a rendering direction;
wherein N is a positive integer.

2. The generation method of claim 1, wherein the processing unit rendering N first disparity images comprises:
the processing unit computing a virtual disparity along the rendering direction based on the first disparity map; and
the processing unit computing the N first disparity images based on the first disparity map and the virtual disparity.

3. The generation method of claim 1, wherein each of the N first disparity images comprises a plurality of valid pixels and a plurality of holes, and the generation method further comprises:
the processing unit generating an image processing window, the image processing window comprising at least one part of the plurality of valid pixels and at least one part of the plurality of holes, wherein the at least one part of the plurality of valid pixels is beside the at least one part of the plurality of holes, and the at least one part of the plurality of holes is adjacent to a window edge of the image processing window; and
the processing unit filling the at least one part of the plurality of holes based on the at least one part of the plurality of valid pixels.

4. The generation method of claim 1, further comprising:
the processing unit rendering M second disparity images based on the Nth first disparity image along a reverse rendering direction opposite to the rendering direction, wherein M is a positive integer and equals N, and the Mth second disparity image is substantially identical to the first view;
wherein the processing unit rendering M second disparity images based on the Nth first disparity image along a reverse rendering direction opposite to the rendering direction comprises:
the processing unit computing a reverse virtual disparity along the reverse rendering direction; and
the processing unit computing the M second disparity images based on the Nth first disparity image and the reverse virtual disparity.

5. The generation method of claim 4, wherein each of the M second disparity images comprises a plurality of valid pixels and a plurality of holes, and the generation method further comprises:
the processing unit generating an image processing window comprising at least one part of the plurality of valid pixels and at least one part of the plurality of holes, wherein the at least one part of the plurality of valid pixels is beside the at least one part of the plurality of holes, and the at least one part of the plurality of holes is adjacent to a window edge of the image processing window; and
the processing unit filling the at least one part of the plurality of holes based on the at least one part of the plurality of valid pixels.

6. The generation method of claim 4, further comprising:
the processing unit segmenting the first view into a first view strip set along a segmenting direction obliquely intersecting an edge of the first view;
the processing unit respectively segmenting the N first disparity images into N first disparity image strip sets along the segmenting direction;
the processing unit respectively segmenting the M second disparity images into M second disparity image strip sets along the segmenting direction; and
the processing unit interlacing the first view strip set, the N first disparity image strip sets, and the M second disparity image strip sets for rendering a display image.

7. The generation method of claim 4, further comprising:
the processing unit rendering P third disparity images based on the Mth second disparity image along the reverse rendering direction, wherein P is a positive integer;
wherein the processing unit rendering the P third disparity images based on the Mth second disparity image along the reverse rendering direction comprises:
the processing unit computing a reverse virtual disparity along the reverse rendering direction; and
the processing unit computing the P third disparity images based on the Mth second disparity image and the reverse virtual disparity.

8. The generation method of claim 7, wherein each of the P third disparity images comprises a plurality of valid pixels and a plurality of holes, and the generation method further comprises:
the processing unit generating an image processing window comprising at least one part of the plurality of valid pixels and at least one part of the plurality of holes, wherein the at least one part of the plurality of valid pixels is beside the at least one part of the plurality of holes, and the at least one part of the plurality of holes is adjacent to a window edge of the image processing window; and
the processing unit filling the at least one part of the plurality of holes based on the at least one part of the plurality of valid pixels.

9. The generation method of claim 7, further comprising:
the processing unit rendering Q fourth disparity images based on the Pth third disparity image along the rendering direction, wherein Q is a positive integer and equals P, and the Qth fourth disparity image is substantially identical to the first view;
wherein the processing unit rendering Q fourth disparity images based on the Pth third disparity image along the rendering direction comprises:
the processing unit computing a virtual disparity along the rendering direction; and
the processing unit computing the Q fourth disparity images based on the Pth first disparity image and the virtual disparity.

10. The generation method of claim 9, wherein each of the Q fourth disparity images comprises a plurality of valid pixels and a plurality of holes, and the generation method further comprises:
the processing unit generating an image processing window comprising at least one part of the plurality of valid pixels and at least one part of the plurality of holes, wherein the at least one part of the plurality of valid pixels is beside the at least one part of the plurality of holes, and the at least one part of the plurality of holes is adjacent to a window edge of the image processing window; and
the processing unit filling the at least one part of the plurality of holes based on the at least one part of the plurality of valid pixels.

11. The generation method of claim 9, further comprising:
the processing unit segmenting the first view into a first view strip set along a segmenting direction obliquely intersecting an edge of the first view;
the processing unit respectively segmenting the N first disparity images into N first disparity image strip sets along the segmenting direction;
the processing unit respectively segmenting the M second disparity images into M second disparity image strip sets along the segmenting direction;
the processing unit respectively segmenting the P third disparity images into P third disparity image strip sets along the segmenting direction;
the processing unit respectively segmenting the Q fourth disparity images into Q fourth disparity image strip sets along the segmenting direction; and
the processing unit interlacing the first view strip set, the N first disparity image strip sets, the M second disparity image strip sets, the P third disparity image strip sets, and the Q fourth disparity image strip sets for rendering a display image.

12. The generation method of claim 1, further comprising:
the processing unit computing a depth of the first disparity map by analyzing the first disparity map; and
the processing unit normalizing the depth with respect to a depth displaying allowance of a display device for allowing the depth of the first disparity map to be compatible with the depth displaying allowance of the display device.

13. A displaying method for a multi-view auto-stereoscopic image, comprising:
providing a first disparity image and at least one second disparity image;
a processing unit segmenting the first disparity image into a first disparity image strip set along a segmenting direction obliquely intersecting an edge of the first disparity image;
the processing unit segmenting the at least one second disparity image into at least one second disparity image strip set along the segmenting direction;
the processing unit interlacing the first disparity image strip set and the at least one second disparity image strip set for rendering a display image; and
the processing unit controlling a display device to display the display image;
wherein the segmenting direction is decomposed into a first component along a first direction and a second component along a second direction perpendicular to the first direction, each of the first component and the second component is greater than zero, the display device has a portrait displaying mode and a landscape displaying mode, the segmenting direction comprises a portrait direction and a landscape direction substantially perpendicular to the portrait direction;
wherein when the display device displays the display image at the portrait displaying mode, the processing unit segments the first disparity image and the at least one second disparity image along the portrait direction;
wherein when the display device displays the display image at the landscape displaying mode, the processing unit segments the first disparity image and the at least one second disparity image along the landscape direction.

14. The displaying method of claim 13, further comprising:
providing an oblique lenticular lens layer comprising a plurality of oblique lenticular lenses, wherein an orientation of each of the plurality of oblique lenticular lenses obliquely intersects an edge of the oblique lenticular lens layer; and
disposing the oblique lenticular lens layer on the display device with the orientation of each of the plurality of oblique lenticular lenses substantially parallel to the segmenting direction.

15. An electronic apparatus, comprising:
a display device for displaying a display image, the display image being a multi-view auto-stereoscopic image, the display image comprising a first disparity image strip set and at least one second disparity image strip set, the first disparity image strip set and the at least one second disparity image strip set obliquely intersecting an edge of the display image; and
an oblique lenticular lens layer disposed on the display device and comprising a plurality of oblique lenticular lenses, an orientation of each of the plurality of oblique lenticular lenses obliquely intersecting an edge of the oblique lenticular lens layer, and an orientation of the first disparity image strip set and an orientation of the at least one second disparity image strip set being substantially parallel to the orientation of each of the plurality of oblique lenticular lenses;
wherein the display device has a portrait displaying mode and a landscape displaying mode;
wherein when the display device displays the display image at the portrait displaying mode, the orientation of the first disparity image strip set and the orientation of the at least one second disparity image strip set are substantially parallel to a portrait direction;
wherein when the display device displays the display image at the landscape displaying mode, the orientation of the first disparity image strip set and the orientation of the at least one second disparity image strip set are substantially parallel to a landscape direction;
wherein the portrait direction is substantially perpendicular to the landscape direction.
